(19) United States
(12) Patent Application Publication
(10) Pub. No.: US 2025/0077770 A1
(43) Pub. Date: Mar. 6, 2025

(54) METHOD FOR CHECKING MESSAGE, TERMINAL DEVICE AND STORAGE MEDIUM

(71) Applicant: PAX COMPUTER TECHNOLOGY (SHENZHEN) CO.,LTD., Shenzhen (CN)

(72) Inventors: CHUNHUA ZHONG, Shenzhen (CN); XIANRONG YANG, Shenzhen (CN)

(21) Appl. No.: 18/721,659

(22) PCT Filed: Aug. 30, 2022
(86) PCT No.: PCT/CN2022/115887

§ 371 Date: Jun. 19, 2024

(30) Foreign Application Priority Data
Dec. 24, 2021 (CN) 202111602016.6

(51) Int. Cl. G06F 40/226; G06F 11/36

(52) U.S. Cl. CPC G06F 40/226; G06F 11/36

(57) ABSTRACT

The present application provides a method for checking message, a terminal device and a storage medium. The method includes obtaining an actual message generated by a payment application during a transaction process, parsing the actual message to obtain the corresponding message parsing result, obtaining the expected message corresponding to the actual message and verifying the message parsing result according to the value of each field in the expected message.

The present application claims the priority to Chinese patent application with application No. 202111602016.6, filed on Dec. 24, 2021, the content of the present application is incorporated herein by reference.

### FIELD

The present application relates to a field of testing software technology, and specifically to a method for checking message, a terminal device and a storage medium.

### BACKGROUND

As people's requirements for high-quality software (such as in payment applications) are getting higher and higher, it is becoming more and more important to test software. Some large and medium-sized clients have particularly stringent requirements for the quality of the software; each release of a new version needs to check all transaction messages. A method for checking the transaction messages manually in existing technologies, which is low-efficient. Whether in a debugging phase or a testing phase, it takes a lot of time and is prone to errors.

### BRIEF DESCRIPTION OF THE DRAWINGS

In order to more clearly illustrate technical solutions in the embodiments of the present application, the drawings required for use in the embodiments, or the description of prior art will be briefly introduced below. Obviously, drawings described below are only some embodiments of the present application. For ordinary technicians in this field, other drawings can be obtained based on the drawings without paying any creative labor.

FIG. 1 is a schematic diagram of an implementation flowchart of a method for checking message provided by a first embodiment of the present application.

FIG. 2 is an example diagram of a configuration file.

FIG. 3 is an example diagram of a network architecture for checking message.

FIG. 4 is a schematic diagram of an implementation flowchart of a method for checking message provided by a second embodiment of the present application.

FIG. 5 is an example diagram of an expected message in Excel.

FIG. 6 is another example diagram of an expected message in Excel.

FIG. 7 is a schematic diagram of a structural of an apparatus for checking message provided by a third embodiment of the present application.

FIG. 8 is a schematic diagram of a structural of a terminal device provided by a fourth embodiment of the present application.

### DESCRIPTION

In following description, specific details such as specific system structures, technologies, etc. are provided for a purpose of illustration rather than limitation, so as to provide a thorough understanding of embodiments of the present application. However, it should be clear to those skilled in the art that the present application may also be implemented in other embodiments without these specific details. In other cases, detailed descriptions of well-known systems, devices, circuits, and methods are omitted to prevent unnecessary details from obstructing the description of the present application.

It should be understood that when used in this specification and the appended claims, the term “comprising” indicates presence of described features, integers, steps, operations, elements and/or components, but does not exclude the presence or addition of one or more other features, integers, steps, operations, elements, elements and/or components thereof.

As used in the specification and the appended claims of the present application, the term “if” can be interpreted as “when . . . ” or “once” or “in response to determining” or “in response to detecting” depending on context. Similarly, a phrase “if it is determined” or “if it is detected [the described condition or event]” can be interpreted as meaning “once it is determined” or “in response to determining” or “once it is detected [the described condition or event]” or “in response to detecting [the described condition or event]” depending on the context.

In addition, in the description of the specification and the appended claims of the present application, the terms “first”, “second”, “third”, etc. are only used to distinguish description and cannot be understood as indicating or implying relative importance.

The reference to “one embodiment” or “some embodiments” etc. described in the specification of the present application means that one or more embodiments of the present application include specific features, structures or characteristics described in conjunction with the embodiment. Therefore, the sentences “in one embodiment”, “in some embodiments”, “in some other embodiments”, “in other embodiments”, etc. appearing in different embodiments of the specification do not necessarily refer to the same embodiment, but mean “one or more but not all embodiments”, unless otherwise specifically emphasized. The terms “include”, “comprises”, “has” and their variations all mean “including but not limited to”, unless otherwise specifically emphasized.

It should be understood that the order of execution of steps in this embodiment does not mean an order of execution. The execution order of each process should be determined by its function and internal logic and should not constitute any limitation on the implementation process of the embodiment of the present application.

In order to illustrate the technical solution described in this application, the following is an illustration through a specific embodiment.

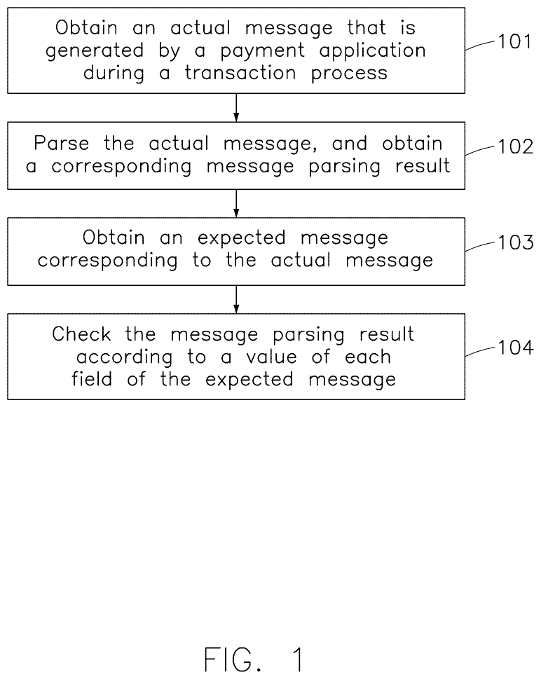

Referring to FIG. 1, it is a schematic diagram of an implementation flowchart of a method for checking message provided in a first embodiment of the present application, and the method for checking message is applied to a terminal device. As shown in FIG. 1, the method for checking message may include the following steps:
Step 101, an actual message that is generated by a payment application during a transaction process is obtained.

Among them, the payment application may be any application with a payment function. For example, Alipay, Cloud QuickPass, PayPal, Palm Life, etc.

Since the transaction of the payment application may have one message, or at least two messages, the number of the actual message of the above 101 may be one, or at least two.

The above actual message is the message actually generated by the payment application during the transaction process, including but not limited to the message sent and received by the payment application during the transaction process.

In an embodiment, the actual message generated by the payment application during the transaction process can be obtained by log cat. An implementation method includes obtaining a transaction log generated by the payment application during the transaction process and intercepting the actual message from the transaction log according to a first keyword and/or a second keyword using a preset regular expression. The first keyword indicates a start interception position of the message sent by the payment application during the transaction process. The second keyword indicates a start interception position of the message received by the payment application during the transaction process.

Among them, the regular expression may represent intercepting all characters of the transaction log that are located in the same line as the first keyword and after the first keyword, or all characters that are located in the same line as the second keyword and after the second keyword.

In one example, the first keyword may be “SEND” and the second keyword may be “RECV”. The above regular expression may be: (? &lt;=SEND:).*| (? &lt;=RECV:).*. The “(? &lt;=SEND:)” means intercepting all characters after “SEND”. For example, a string is “MSAGE_SEND:60 . . . ”, then the intercepted characters are “60 . . . ”. The “.*” means intercepting all characters in a certain line. The (? &lt;=RECV:) means intercepting all characters after “RECV”. The “(? &lt;=SEND:).*| (? &lt;=RECV:).*” means intercepting all characters in the transaction log that are in the same line as “SEND” and after “SEND”, or in the same line as “RECV” and after “RECV”.
Step 102, the actual message is parsed, and a corresponding parsing result is obtained.

The parsing result corresponding to the actual message is obtained by parsing the actual message according to a preset configuration file.

Among them, the configuration file is used to define a format, a length and other information of the data of each field in the ISO8583 message. The definitions of the terms in the configuration file are as follows:
A: letters, which are close to left, and the excess part on the right is filled with spaces.
N: numbers, which are close to right, with zeros before a first valid digit. If it represents an amount, two digits located at the extreme right are indicates dime and penny.
S: special “symbol”.
AN: letters and/or numbers, which are close to left, and the excess part on the right is filled with spaces. AN may include both A and N.
ANS: letters, numbers and/or special symbols, which are close to left, and the excess part on the right is filled with spaces. ANS may include both A, N and S.
AS: letters and/or special symbols, which are close to left, and the excess part on the right is filled with spaces.
B: binary byte (bit).
Z: Data type of the second and third tracks of a magnetic card specified by ISO7811 and ISO7813.
ANS . . . 999 (LLLVAR): This variable may include letters, numbers and special symbols, with a maximum length of 999 characters, and the length is determined by a number with three digits.
N . . . 999 (LLLVAR): When compressed, a bit of length is compressed with a binary-coded decimal (BCD) code which is close to right, and digital content immediately following the bit of length is compressed with the BCD code which is close to the left. which can ensure that there is no default padding value between the valid content and the digits. If the digits are not even numbers, after the digital content which is close to the left are padded with zeros. Since the bit of the length represents a length of valid content of the field, a true value of the field will not change with the padded zeros.
BCD: Convert BCD to String, for example, 30323030303030363430 in the field of 60 is converted to 0200000640.
Ascii: Convert Ascii code to String, for example, 4D4330303030 in the field of 38 is converted to MC0000.
EMVTLV: Parse EMV data, for example, tag5F2A(5F2A020344) in the field of 55 is converted to [5F2A:0344].
TLV: Parse values of a predefined field, for example, tag11(3131000740213030322140) in the field of 63 is converted to [‘11’, ‘0007@!002!@’].
LTV: Parse values of a predefined field, for example, tag12 (0003313258) of the field of 63 is converted to [‘12’, ‘0001X].
SP: Parse values of a special field. After the format of the data is defined as SP, the Unpack interface needs to be implemented to support predefined message parsing rules.

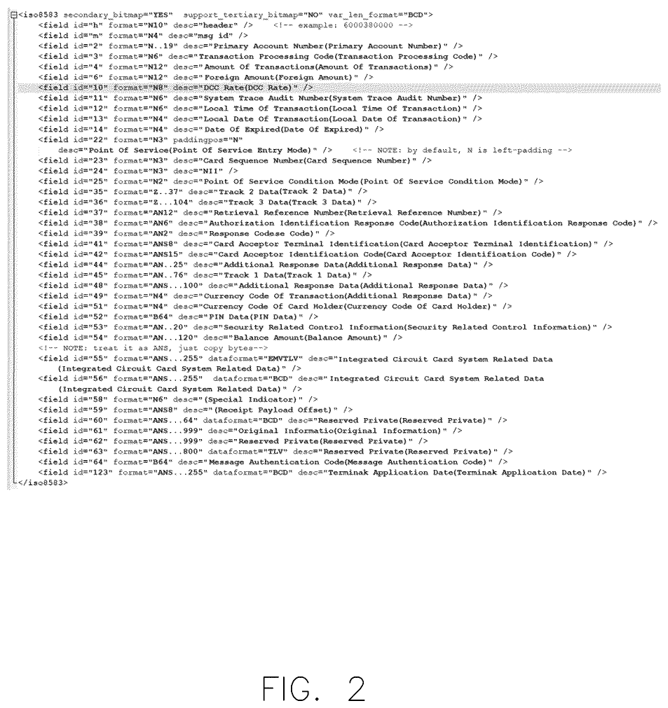

As shown in FIG. 2, an example diagram of a configuration file is shown.

In an embodiment, an interface for parsing the message can be invoked to parse the actual message according to the data format defined in the configuration file.

Among them, the interface for parsing the message is an interface opened separately from a message parsing module. The configuration file and the actual message to be parsed can be transmitted through the interface, and the parsing result corresponding to the actual message can be returned in a form of a dictionary. The above-mentioned interface for parsing the message can be called as an Unpack Message interface, and the Unpack Message interface is a java library.

In an actual application scenario, a process for obtaining the parsing result includes: executing adb log cat-c to clear the log cached before executing the transaction; executing a command of adb log cat-s findstr tag to filter the log output by the log cat according to a tag; manually or using an automated script to execute the transaction of the payment application, and the log output by log cat in this process is the above-mentioned transaction log; saving the log output by log cat to a txt file and storing the log based on a path specified by a log_path parameter; reading content of the txt file, and intercepting the actual message of the txt file by using a preset regular expression according to the first keyword and/or the second keyword; invoking the java library, and loading the configuration file in xml format by the java library, and parsing the actual message according to the data format defined in the configuration file; obtaining the parsing result by parsing the actual message and storing the parsing result in a dictionary. Since a transaction may have multiple messages, and the process for obtaining the above parsing result can be executed cyclically, to store the message parsing result of all actual messages generated by the transaction of the payment application in a collection.

Among them, three libraries of operation system (OS), subprocess and re of python can be used to obtain and intercept the actual message from the transaction log. The implementation steps are as follows:
1) invoking a method of os.system to execute the adb log cat-c, to clear the log cached before executing the transaction.
2) invoking a method of subprocess.Popen to execute the command of the adb log cat-s findstr tag to filter the log output by log cat.
3) invoking the method of subprocess.Popen to create a file handle and store data output by log cat in a txt file.
4) invoking an open method to open the txt file.
5) invoking a re.findall( ) method to intercept the actual message using the preset regular expression.

It should be noted that the actual message in the application is an ISO8583 message, and the above-mentioned java library for parsing the actual message can be called ISO8583_TelegramUtil_V1.00.01.jar.

Use the java library (ISO8583_TelegramUtil_V1.00.01.jar) introduced by the jpype library of python to parse the actual message. The java library can parse the actual message according to the data format defined in the configuration file, and the java library finally returns the parsing result. The implementation steps are as follows:
1) starting the JVM by invoking a jpype.getDefaultJVMPath( ) method.
2) loading the jar by invoking an os.path.join( ) method.
3) loading a class of java by invoking a jpype.JClass( ) method.
4) creating an instance object of the java library (Iso8583_TelegramUtil_V1.00.01.jar).
5) sending the configuration file and the actual message, and receiving the parsing result parsed by the java library.

Step 103, an expected message corresponding to the actual message is obtained.

The expected message is the message that the payment application should generate during the transaction process and is a valid message.

It should be noted that each actual message generated by the payment application during the transaction process corresponds to an expected message. That is, the number of expected messages is the same as the number of actual messages. According to the expected message corresponding to each actual message, the parsing result of the actual message can be verified.

In an embodiment, obtaining the expected message corresponding to the actual message includes:
Reading the expected message from a target document according to a third keyword, the third keyword represents a reading start position of the expected message, and the target document stores the expected message.

Among them, the above-mentioned target document can be a document in any format, which is not limited here. For example, the format of the above-mentioned target document is Excel format, XML format, etc.

In an example, the third keyword may be “Message Type”. After reading “Message Type” in the target document, the expected message to be read may be matched. When the next “Message Type” is read, stop reading the expected message. The content between the two “Message Type” is a complete expected message.

In an actual application scenario, the above-mentioned expected message obtained process includes: filling in the expected message in the Excel according to a filling rule of the expected message; selecting to obtain the expected message in Excel; opening the Excel file according to filePath parameter; selecting the sheet to be read according to entry_mode parameter; after reading the keyword “Message Type” in the sheet, the expected message to be read may be matched. When the next “Message Type” is read, it indicates that a complete expected message has been read. If there are multiple expected messages, the data is continued to be read until the subsequent content is empty, and the reading operation is stopped. Each expected message read is stored in a dictionary. Since there may be multiple messages in a transaction, the above steps may be executed repeatedly to store all expected messages in a collection.
Step 104, the message parsing result is checked according to a value of each field of the expected message.

According to the value of each field of the expected message, thereby checking the parsing result is realized by comparing the message parsing result corresponding to the actual message with the expected message.

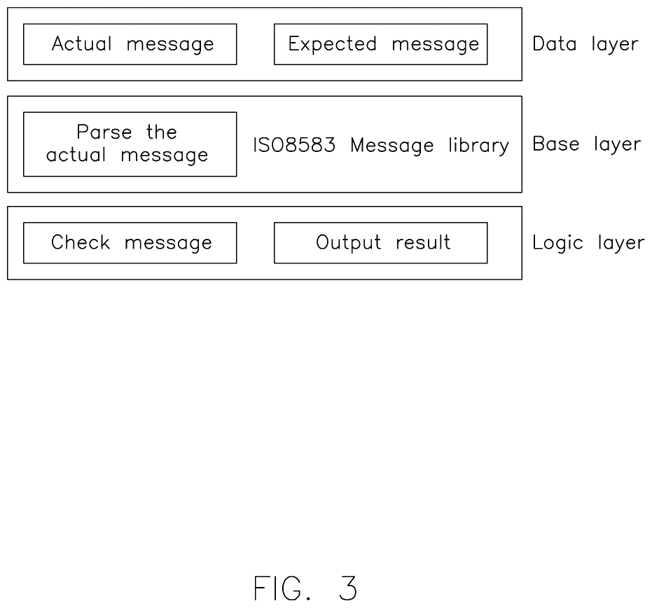

As shown in FIG. 3, it is an example diagram of the network architecture for checking message, and the network architecture includes a data layer, a basic layer and a logic layer. The data layer is mainly used to obtain the actual message and the expected message. The basic layer is mainly an ISO8583 message library, which is used to parse the actual message. The logic layer is mainly used to check the message parsing result obtained by parsing the actual message with the expected message, and output a verification result.

In a practical application scenario, a set of message parsing result and a set of expected messages can be obtained. The set of the message parsing result and the set of the expected messages are traversed respectively, and all dictionaries of the set of the message parsing result are obtained and all dictionaries of the set of the expected messages are obtained. All dictionaries of the set of the message parsing result and all dictionaries of the set of expected messages are traversed, and the message parsing result stored in each dictionary of the set of message parsing result is obtained and the expected message stored in each dictionary of the set of expected messages is obtained.

The message parsing result corresponding to the expected message is checked according to the value of each field of each expected message, and the check of each actual message generated by the payment application in the transaction process can be realized. After the set of all message parsing results and the set of expected messages are traversed, the check result of each message parsing result is returned, and the log of the detailed expected message and the message parsing result is output for subsequent viewing.

In an embodiment, further includes:
obtaining a value of the specified field from the message parsing result by invoking a specified field interface of the message;
executing a special transaction of the payment application according to a value of the specified field.

By invoking the specified field interface of the message, the type of the message and a set of specified fields to be obtained can be sent, and the values of the specified field can be returned in the form of a set. Among them, the above-mentioned specified field interface of the message can be called as a Get Parameter interface.

When writing a user interface (UI) automation script, some special transactions require input of parameters returned by the background of the payment application to complete the transaction. For example, when executing a refund, canceling pre-authorization, completing pre-authorization, etc., it is necessary to input the retrieval reference number, authorization identification reply code and other parameters on the original transaction to complete the transaction. However, these parameters are not displayed on the UI of the application layer, resulting in the inability to obtain these parameters from the UI of the application layer when writing the UI automation script, because the UI automation test can only obtain the data displayed on the page, and cannot obtain the data not displayed on the page. If the UI automation script arbitrarily enters the retrieval reference number, authorization identification replies code and other parameters, the background and terminal equipment will fail to verify, and the expected test effect cannot be achieved. The present application can obtain the value of the specified field from the parsing result of the actual message returned by the background through the message specified field interface. For example, obtain the value of the 37 field (retrieval reference number), the value of the 38 field (authorization identification reply code), etc. from the message parsing result of the returned actual message, and then apply the obtained retrieval reference number, authorization identification replies code and other parameters to the UI automation script, thereby solving the problem that special transactions cannot be tested by automation.

The embodiment of the present application obtains the actual message generated by the payment application during the transaction process and parses the actual message to obtain the parsing result of the actual message. The parsing result of the actual message can be checked according to the value of each field in the expected message corresponding to the actual message. No manual reference is required during checking, which improves efficiency and accuracy for checking the message.

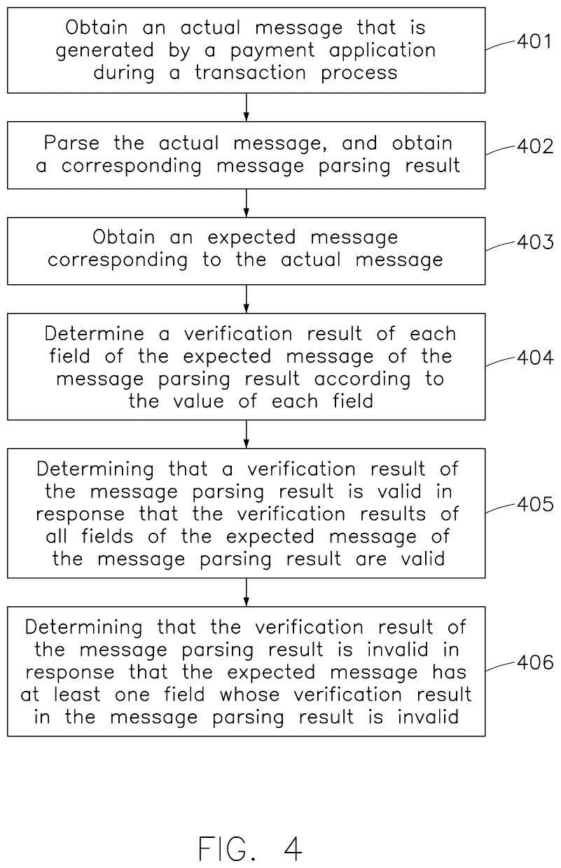

Referring to FIG. 4, it is a schematic diagram of the implementation flowchart of the method for checking message provided in the second embodiment of the present application, and the method for checking the message is applied to a terminal device. As shown in FIG. 4, the method for checking the message may include the following steps:
Step 401, an actual message that is generated by a payment application during a transaction process is obtained.

This step is the same as the step 101, and a relevant description of step 101 can be specifically referred to, which will not be repeated here.
Step 402, the actual message is parsed, and a corresponding parsing result is obtained.

This step is the same as step 102, and a relevant description of step 102 can be specifically referred to, which will not be repeated here.

The configuration file used to parse the actual message pre-defines the message header, Message Type, and the data type, data format, data length and annotation of each field of 2 to 64 fields according to the characteristics of ISO8583. Generally, only the type of the data format of the custom field needs to be modified to parse different types of transaction messages such as sale, void, refund, offline, PreAuth, adjust, installment, settlement, etc.
Step 403, an expected message corresponding to the actual message is obtained.

This step is the same as step 103, and a relevant description of step 102 can be specifically referred to, which will not be repeated here.
Step 404, a verification result of each field of the expected message of the message parsing result is determined according to the value of each field.

For example, for field 35 of the expected message, according to the value of the field 35 of the expected message, the verification results of the field 35 of the expected message of the parsing result can be determined.

In one embodiment, a filling rule of the expected message can be obtained according to the message that the payment application should generate during the transaction process, and the filling rule at least includes the fields that should be included in the expected message and the value of each field. Based on the filling rule, the expected message can be filled in and stored in the target document.

In an embodiment, according to the value of each field of the expected message, determining the verification result of each field of the expected message of the parsing result includes:
If a value of a certain field of the expected message is a first character, the field is determined to be a first field, and whether the message parsing result includes the first field is determined, and the first character indicates that the message parsing result need to include the first field.
If the message parsing result includes the first field, the verification result of the first field in the message parsing result is determined to be valid.
If the message parsing result does not include the first field, the verification result of the first field in the message parsing result is determined to be invalid.
If the value of the certain field of the expected message is a second character, the field is determined to be a second field, and it is determined whether the second field is not included in the message parsing result, and the second character indicates that the second field cannot be included in the message parsing result.
If the message parsing result does not include the second field, the verification result of the second field in the message parsing result is determined to be valid.
If the message parsing result includes the second field, the verification result of the second field in the message parsing result is determined to be invalid.
If the value of a certain field in the expected message is a third character, determining whether the message parsing result includes the field is skipped, and the third character indicates that a corresponding field is an optional field of the message parsing result.
If the value of a field of the expected message is other characters, the field is determined to be other fields, and it is determined whether the message parsing result includes other fields, and when the message parsing result includes the other fields, it is determined whether the values of the other fields in the expected message and in the message parsing result are consistent, and the other characters refer to characters other than the first character, the second character and the third character.
If the message parsing result includes the other fields and the values of the other fields in the expected message and in the message parsing result are consistent, then it is determined that the verification result of the other fields in the message parsing result is valid.
If the message parsing result does not include the other fields, or includes the other fields and the values of the other fields in the expected message are inconsistent with the values of the other fields in the message parsing result, then it is determined that the verification result of the other fields in the message parsing result is invalid.

Among them, the first field is a field that must be included in the message parsing result. That is, a field that must be included in the actual message. The second field is a field that cannot be included in the message parsing result. That is, a field that cannot be included in the actual message. The third field is a dispensable field (i.e., an optional field) in the message parsing result. That is, a dispensable field in the actual message. Other fields are fields that must be included in the message parsing result and the values of the fields in the message parsing result are consistent with the values of the fields in the expected message. Determining whether the values of other fields in the expected message are consistent with the values of other fields in the message parsing result can refer to determining whether the values of other fields in the message parsing result are other characters corresponding to other fields. For example, if the value of field 22 in the expected message is equal to 051, then it can be determined that 051 is other characters, field 22 is other fields, and it is determined whether the value of field 22 in the message parsing result is equal to 051. If the value of field 22 in the message parsing result is equal to 051, it can be determined that the verification result of field 22 in the message parsing result is valid; if the value of field 22 in the message parsing result is not equal to 051, it can be determined that the verification result of field 22 in the message parsing result is invalid.

For example, “Y” can be used to represent the first character, “N” can be used to represent the second character, and “O” can be used to represent the third character. Other characters can be characters other than “Y”, “N”, and “O”.

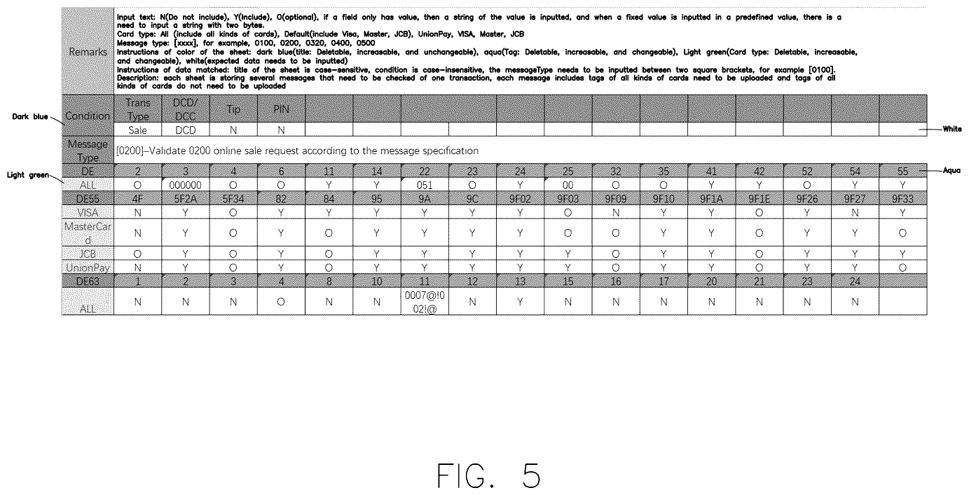

As shown in FIG. 5, an example diagram of an expected message in Excel is shown. FIG. 5 is a diagram of storing the expected message in Excel. The filling specifications in Excel are as follows:
1) a table name of the Excel: generally named after the type of the transaction, which is convenient for distinguishing different transactions and facilitating future maintenance.
2) a name of Sheet: generally named after ways for holding a card, such as Insert, Swipe, Fallback, Manual, Tap, etc., and the name can also be predefined.
3) color of the Table: dark blue (title: cannot be modified, cannot be edited, can be appended), aqua (Tag: can be added, deleted, and modified), light green (Card Type: can be added, deleted, and modified), white (data of the expected message to be filled).
4) Message Type: [0100], [0200], [0320], [0400], [0500], etc.
5) Card Type: ALL (including all types of cards), Default (including Visa, Master, JCB), UnionPay, VISA, Master, JCB, AMEX, etc.
6) Input text (message data to be input): N (indicating a field that must not be included), Y (indicating a field that must be included), value (e.g. 03 field: 000030, indicating that the value of 03 field must be 000030), O (indicating an optional, uninvolved field), and a 2-byte string length can be included when filling in the value of the DE special field.

“Condition” in FIG. 5 indicates a condition of the transaction, “Trans Type” indicates a type of the transaction, “DCD” indicates US dollars, “DCC” indicates RMB, “Tip” indicates a tip, and “PIN” indicates a password.

The present application can flexibly set the format of the expected message by setting the first character, the second character, the third character and other characters in Excel, thereby obtaining a more detailed verification process and realizing diversified configuration.

When obtaining the expected message from Excel, the three python libraries xlrd, json, and re are mainly used. The xlrd is responsible for processing the Excel table, json is responsible for converting the obtained data, and re is responsible for filtering and reading data using the regular expression. The implementation steps are as follows:
1) a method of xlrd.open_workbook( ) is invoked to open the Excel table.
2) a method of row_values( ) is invoked to obtain key information in the Excel table, such as sheet name, Message Type and other data.
3) the sheet name, Message Type, trans_type and other data are verified.
4) After the verification is passed, the value of the field of the Message Type (such as DE in FIG. 5) is obtained.
5) the value of special fields such as DE55 or DE63 is obtained.
6) the obtained field value is converted into json format by invoking a method of json.dumps( ).

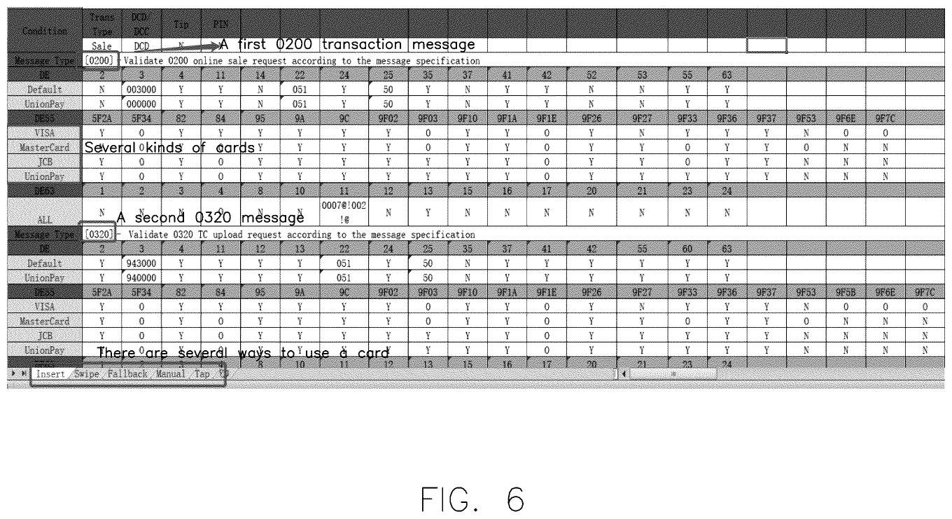

The expected message is managed in Excel. An Excel sheet can be divided into multiple sheets, and one sheet can store multiple messages. For example, a sale transaction will send multiple messages, and support multiple types of cards and multiple different card usage methods. As shown in FIG. 6, it is another example diagram of the expected message in Excel, and FIG. 6 includes two expected messages.
Step 405, if the verification results of all fields in the expected message in the message parsing result are valid, then a verification result of the message parsing result is determined to be valid.

When the verification result of the message parsing result is valid, an identifier indicating validness (for example, true) can be returned.
Step 406, if the expected message has at least one field whose verification result in the message parsing result is invalid, the verification result of the message parsing result is determined to be invalid.

When the verification result of the message parsing result is invalid, the field whose verification result is invalid can be returned.

Since a transaction may generate multiple actual messages, and each actual message includes multiple fields, all actual messages of the entire transaction can be checked at one time, and a detailed check result can be returned. If all messages are checked as valid, true is returned. If one message fails to check, the value of the field that failed to be checked in the expected message and the value of the message parsing result of the actual message are returned. The work will not be stopped because a message parsing result or a field is inconsistent with the expected message during the check process.

Based on the first embodiment, the embodiment of the present application can determine the verification result of each field in the expected message in the message parsing result according to the value of each field in the expected message. The check process does not require manual reference, thereby improving efficiency and accuracy for checking the message.

In some embodiments, program code for implementing the scheme for checking the message of the first and second embodiments can be stored in a library of PAX_Check8583Library. The PAX_Check8583Library is a Python test library of the Robot framework automation framework. When running the automation script, it can automatically check whether the transaction message is valid, thereby improving the test efficiency, reducing the test cost, and effectively avoiding the problem of easy errors in manual verification, thereby improving quality of product, and also solving the problem that special transactions cannot be tested by automation.

In an existing solution, the actual message is usually parsed using a tool for parsing the message, which is a PDA. Since the tool of the PDA for parsing the message cannot parse the predefined fields (such as the predefined fields such as 60/62/63 fields of ISO8583 messages), testers and developers need to manually parse the predefined fields to determine whether the message sent by the predefined field is valid. The PAX_Check8583Library not only implements the PDA message parsing function, but also provides an interface for parsing the predefined fields (i.e., the Unpack Message interface). As long as the interface is implemented, each IOS8583 message of the entire project can be parsed in the form of a string.

The PAX_Check8583Library in this application has good usability. Whether in a process of testing or a process of debugging, as long as there is a python environment, the PAX_Check8583Library can be run to check the transaction message.

In actual applications, the present application can complete the function of automatically checking transaction messages by invoking three interfaces, which are Set Attr (initialization data), Start Check Iso8583 (start monitoring), and Stop Check Iso8583 (stop monitoring and check messages). After the PAX_Check8583Library is released, the three interfaces are open. Users of the library can invoke the three interfaces to realize automatic verification of transaction messages. The PAX_Check8583Library obtains the actual messages from transaction logs and parses the actual messages. The application under test (i.e., payment application) does not need to provide additional interfaces. Any payment application can use all functions of the library normally as long as it prints messages in log cat.

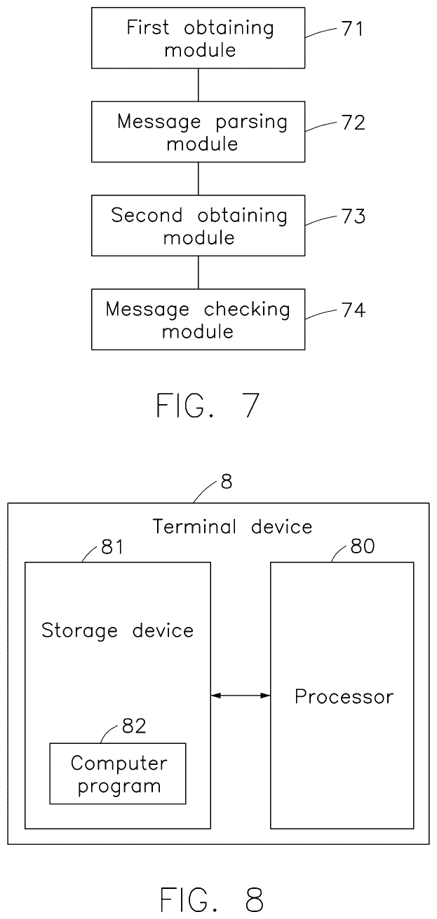

Corresponding to the method for checking the message described in the above embodiment, FIG. 7 shows a structural block diagram of an apparatus for checking the message provided in the third embodiment of the present application. For the sake of convenience, only the part related to the embodiment of the present application is shown.

Referring to FIG. 7, the apparatus for checking the message includes:
A first obtaining module 71, used to obtain an actual message that is generated by a payment application during a transaction process;
A message parsing module 72, used to parse the actual message and obtain a corresponding message parsing result;
A second obtaining module 73, used to obtain an expected message corresponding to the actual message;
A message checking module 74, used to check the message parsing result according to a value of each field of the expected message.

In some embodiments, the message checking module 74 includes:
A checking unit, used to check a verification result of each field of the expected message of the message parsing result according to the value of each field of the expected message.
A first determination unit, used to determine that a verification result of the message parsing result is valid in response that the verification results of all fields of the expected message of the message parsing result are valid.
A second determination unit, used to determine that the verification result of the message parsing result is invalid in response that the expected message has at least one field whose verification result in the message parsing result is invalid.

In some embodiments, the above-mentioned checking unit is specifically used to:
in response that a value of a certain field of the expected message is a first character, determining the certain field to be a first field, and determining whether the message parsing result has the first field, the first character indicating that the message parsing result needs to have the first field;
in response that the message parsing result comprises the first field, determining that the verification result of the first field in the message parsing result is valid;
in response that the message parsing result does not comprise the first field, determining that the verification result of the first field in the message parsing result is invalid;
in response that the value of the certain field of the expected message is a second character, determining that the certain field is a second field, and determining whether the message parsing result does not have the second field, and the second character indicating that the message parsing result does not have the second field;
in response that the message parsing result does not comprise the second field, determining that the verification result of the second field in the message parsing result is valid;
in response that the message parsing result has the second field, determining that the verification result of the second field in the message parsing result is invalid;
in response that the value of the certain field in the expected message is a third character, skipping to determine whether the message parsing result has the field, and the third character indicating that a corresponding field is an optional field of the message parsing result;
in response that the value of the certain field in the expected message is other character, determining that the certain field is other field, and determining whether the message parsing result has the other field, and in response that the message parsing result has the other field, determining whether a value of the other field in the expected message is consistent with the value of the other field in the message parsing result, and the other character representing a character except the first character, the second character and the third character;
in response that the message parsing result has the other field and the value of the other field in the expected message is consistent with the value of the other field in the message parsing result, determining that the verification result of the other field in the message parsing result is valid;
in response that the message parsing result does not has the other field, or has the other field and the value of the other field in the expected message is inconsistent with the value of the other field in the message parsing result, determining that the verification result of the other field in the message parsing result is invalid.

In some embodiments, the first obtaining module 71 is specifically used for:
obtaining a transaction log that is generated by the payment application during the transaction process; and
intercepting the actual message from the transaction log according to a first keyword and/or a second keyword using a preset regular expression, the first keyword indicating a start interception position of the message sent by the payment application during the transaction process, the second keyword indicating a start interception position of the message received by the payment application during the transaction process.

In some embodiments, the second obtaining module 73 is specifically used for:
reading the expected message from a target document according to a third keyword, the third keyword representing a reading start position of the expected message, and the target document storing the expected message.

In some embodiments, the message parsing module 72 is specifically used for:
parsing the actual message according to a data format defined in the configuration file by invoking an interface that is used to parse the message.

In some embodiments, the apparatus for checking the message includes:
An interface invoking module, used to obtain a value of a specified field from the message parsing result by invoking a specified field interface of the message.
A transaction execution module, used to a special transaction of the payment application according to the value of the specified field.

It should be noted that the information interaction, execution process and other contents between the above-mentioned devices/units are based on the same concept as the method embodiment of the present application. Their specific functions and technical effects can be specifically referred to in the method embodiment part, and will not be repeated here.

FIG. 8 is a schematic diagram of the structure of a terminal device provided in the fourth embodiment of the present application. As shown in FIG. 8, the terminal device 8 of the embodiment includes: one or more processors 80 (only one is shown in the figure), a storage device 81, and a computer program 82 stored in the storage device 81 and executable by the processor 80. When the processor 80 executes the computer program 82, the steps in the above-mentioned the method for checking the message in the embodiments are implemented.

The terminal device 8 may be a computing device such as a mobile phone, a point of sales (POS) machine, a desktop computer, a notebook, a PDA, and a cloud server. The terminal device may include, but is not limited to, a processor 80 and a storage device 81. Those skilled in the art may understand that FIG. 8 is only an example of the terminal device 8 and does not constitute a limitation on the terminal device S. It may include more or fewer components than shown in the figure, or a combination of certain components, or different components. For example, the terminal device may also include input and output devices, network access devices, buses, etc.

The processor 80 may be a central processing unit (CPU), or other general-purpose processors, digital signal processors (DSP), application-specific integrated circuits (ASIC), field-programmable gate arrays (FPGA) or other programmable logic devices, discrete gates or transistor logic devices, discrete hardware components, etc. A general-purpose processor may be a microprocessor or the processor may be any conventional processor, etc.

The storage device 81 may be an internal storage unit of the terminal device 8, such as a hard disk or memory of the terminal device 8. The storage device 81 may also be an external storage device of the terminal device 8, such as a plug-in hard disk, a smart media card (SMC), a secure digital (SD) card, a flash card, etc. equipped on the terminal device 8. Further, the storage device 81 may include both an internal storage unit of the terminal device 8 and an external storage device. The storage device 81 is used to store the computer program and other programs and data required by the terminal device. The storage device 81 can also be used to temporarily store data that has been output or is to be output.

Those skilled in the art can clearly understand that for the convenience and simplicity of description, only the division of the above-mentioned functional units and modules is used as an example for illustration. In practical applications, the above-mentioned function allocation can be completed by different functional units and modules as needed, that is, the internal structure of the device can be divided into different functional units or modules to complete all or part of the functions described above. The functional units and modules in the embodiment can be integrated into a processing unit, or each unit can exist physically separately, or two or more units can be integrated into one unit. The above-mentioned integrated unit can be implemented in the form of hardware or in the form of software functional units. In addition, the specific names of the functional units and modules are only for the convenience of mutual distinction and are not used to limit the scope of protection of the present application. The specific working process of the units and modules in the above-mentioned device can refer to the corresponding process in the above-mentioned method embodiment, which will not be repeated here.

The embodiment of the present application also provides a computer-readable storage medium, which stores a computer program. When the computer program is executed by the processor, the steps in the above-mentioned method embodiments can be implemented.

The present application also provides a computer program product, which, when executed on a terminal device, enables the terminal device to implement the steps in the above-mentioned method embodiments.

In the above-mentioned embodiments, the description of each embodiment has its own emphasis. For parts that are not described or recorded in detail in a certain embodiment, please refer to the relevant description of other embodiments.

A person of ordinary skill in the art can realize that the units and algorithm steps of each example described in the embodiments disclosed herein can be implemented in electronic hardware, or a combination of computer software and electronic hardware. Whether these functions are implemented in hardware or software depends on the specific application and design constraints of the technical solution. Professional and technical personnel can use different methods to implement the described functions for each specific application, but such implementation should not be considered to be beyond the scope of the present application.

In the embodiments provided in the present application, it should be understood that the disclosed terminal device, devices and methods can be implemented in other ways. For example, embodiments of the terminal device described above are only schematic. For example, a division of the modules or units is only a division of logical functions. There may be other division methods in actual implementation, such as multiple units or multiple components can be combined or integrated into another system, or some features can be ignored or not executed. Another point is that a mutual coupling or a direct coupling or a communication connection shown or discussed can be an indirect coupling or communication connection through some interfaces, devices or units, which can be electrical, mechanical or other forms.

The units described as separate components may or may not be physically separated, and the components shown as units may or may not be physical units, that is, they may be located in one place or distributed on multiple network units. Some or all of the units may be selected according to actual needs to achieve the purpose of the solution of this embodiment.

If the integrated unit is implemented in the form of a software functional unit and sold or used as an independent product, it can be stored in a computer-readable storage medium. Based on this understanding, the present application implements all or part of the processes in the above-mentioned embodiment method, and can also be completed by instructing the relevant hardware through a computer program. The computer program can be stored in a computer-readable storage medium, and when the computer program is executed by one or more processors, the steps of each of the above-mentioned method embodiments can be implemented. Among them, the computer program includes computer program codes, which may be in a form of source codes, a form of object codes, a form of executable file or some intermediate form, etc. The computer readable medium may include: any entity or device capable of carrying the computer program code, recording medium, USB flash drive, mobile hard disk, magnetic disk, optical disk, computer memory, read-only memory (ROM), random access memory (RAM), electric carrier signal, telecommunication signal and software distribution medium, etc. It should be noted that the content contained in the computer readable medium may be appropriately increased or decreased according to the requirements of legislation and patent practice in the jurisdiction. For example, in some jurisdictions, according to legislation and patent practice, computer readable media do not include electric carrier signals and telecommunication signals.

The embodiments described above are only used to illustrate the technical solutions of the present application, rather than to limit them. Although the present application has been described in detail with reference to the aforementioned embodiments, a skilled in the art should understand that the technical solutions described in the aforementioned embodiments may be modified, or some of the technical features may be replaced by equivalents. Such modifications or replacements do not deviate the essence of the corresponding technical solutions from the spirit and scope of the technical solutions of the embodiments of the present application and should all be included in the protection scope of the present application.

1. A method for checking message, comprising:
obtaining an actual message that is generated by a payment application during a transaction process;
parsing the actual message, and obtaining a corresponding message parsing result;
obtaining an expected message corresponding to the actual message;
checking the message parsing result according to a value of each field of the expected message.

2. The method according to claim 1, wherein checking the message parsing result according to a value of each field of the expected message comprises:
determining a verification result of each field of the expected message of the message parsing result according to the value of each field;
determining that a verification result of the message parsing result is valid in response that the verification results of all fields of the expected message of the message parsing result are valid;
determining that the verification result of the message parsing result is invalid in response that the expected message has at least one field whose verification result in the message parsing result is invalid.

3. The method according to claim 2, wherein determining a verification result of each field of the expected message of the message parsing result according to the value of each field comprises:
in response that a value of a certain field of the expected message is a first character, determining the certain field to be a first field, and determining whether the message parsing result has the first field, the first character indicating that the message parsing result needs to have the first field;
in response that the message parsing result comprises the first field, determining that the verification result of the first field in the message parsing result is valid;
in response that the message parsing result does not comprise the first field, determining that the verification result of the first field in the message parsing result is invalid;
in response that the value of the certain field of the expected message is a second character, determining that the certain field is a second field, and determining whether the message parsing result does not have the second field, and the second character indicating that the message parsing result does not have the second field;
in response that the message parsing result does not comprise the second field, determining that the verification result of the second field in the message parsing result is valid;
in response that the message parsing result has the second field, determining that the verification result of the second field in the message parsing result is invalid;
in response that the value of the certain field in the expected message is a third character, skipping to determine whether the message parsing result has the field, and the third character indicating that a corresponding field is an optional field of the message parsing result;
in response that the value of the certain field in the expected message is other character, determining that the certain field is other field, and determining whether the message parsing result has the other field, and in response that the message parsing result has the other field, determining whether a value of the other field in the expected message is consistent with the value of the other field in the message parsing result, and the other character representing a character except the first character, the second character and the third character;
in response that the message parsing result has the other field and the value of the other field in the expected message is consistent with the value of the other field in the message parsing result, determining that the verification result of the other field in the message parsing result is valid;
in response that the message parsing result does not has the other field, or has the other field and the value of the other field in the expected message is inconsistent with the value of the other field in the message parsing result, determining that the verification result of the other field in the message parsing result is invalid.

4. The method according to claim 1, wherein obtaining an actual message that is generated by a payment application during a transaction process comprises:
obtaining a transaction log that is generated by the payment application during the transaction process; and
intercepting the actual message from the transaction log according to a first keyword and/or a second keyword using a preset regular expression, the first keyword indicating a start interception position of the message sent by the payment application during the transaction process, the second keyword indicating a start interception position of the message received by the payment application during the transaction process.

5. The method according to claim 1, wherein obtaining an expected message corresponding to the actual message comprises:
reading the expected message from a target document according to a third keyword, the third keyword representing a reading start position of the expected message, and the target document storing the expected message.

6. The method according to claim 1, wherein parsing the actual message comprises:
parsing the actual message according to a data format defined in the configuration file by invoking an interface that is used to parse the message.

7. The method according to claim 1, further comprising:
obtaining a value of a specified field from the message parsing result by invoking a specified field interface of the message;
executing a special transaction of the payment application according to the value of the specified field.

8-10. (canceled)

11. A terminal device, comprising:
a storage device storing at least one instruction; and
a processor, when the at least one instruction is executed by the processor, the processor is caused to:
obtain an actual message that is generated by a payment application during a transaction process;
parse the actual message, and obtain a corresponding message parsing result;
obtain an expected message corresponding to the actual message;
check the message parsing result according to a value of each field of the expected message.

12. The terminal device according to claim 11, wherein the processor checks the message parsing result according to a value of each field of the expected message by:
determining a verification result of each field of the expected message of the message parsing result according to the value of each field;
determining that a verification result of the message parsing result is valid in response that the verification results of all fields of the expected message of the message parsing result are valid;
determining that a verification result of the message parsing result is invalid in response that the expected message has at least one field whose verification result in the message parsing result is invalid.

13. The terminal device according to claim 12, wherein the processor determines a verification result of each field of the expected message of the message parsing result according to the value of each field by:
in response that a value of a certain field of the expected message is a first character, determining the certain field to be a first field, and determining whether the message parsing result has the first field, the first character indicating that the message parsing result needs to have the first field;
in response that the message parsing result comprises the first field, determining that the verification result of the first field in the message parsing result is valid;
in response that the message parsing result does not comprise the first field, determining that the verification result of the first field in the message parsing result is invalid;
in response that the value of the certain field of the expected message is a second character, determining that the certain field is a second field, and determining whether the message parsing result does not have the second field, and the second character indicating that the message parsing result does not have the second field;
in response that the message parsing result does not comprise the second field, determining that the verification result of the second field in the message parsing result is valid;
in response that the message parsing result has the second field, determining that the verification result of the second field in the message parsing result is invalid;
in response that the value of the certain field in the expected message is a third character, skipping to determine whether the message parsing result has the field, and the third character indicating that a corresponding field is an optional field of the message parsing result;
in response that the value of the certain field in the expected message is other character, determining that the certain field is other field, and determining whether the message parsing result has the other field, and in response that the message parsing result has the other field, determining whether a value of the other field in the expected message is consistent with the value of the other field in the message parsing result, and the other character representing a character except the first character, the second character and the third character;
in response that the message parsing result has the other field and the value of the other field in the expected message is consistent with the value of the other field in the message parsing result, determining that the verification result of the other field in the message parsing result is valid;
in response that the message parsing result does not has the other field, or has the other field and the value of the other field in the expected message is inconsistent with the value of the other field in the message parsing result, determining that the verification result of the other field in the message parsing result is invalid.

14. The terminal device according to claim 11, wherein the processor obtains an actual message that is generated by a payment application during a transaction process by:
obtaining a transaction log that is generated by the payment application during the transaction process; and
intercepting the actual message from the transaction log according to a first keyword and/or a second keyword using a preset regular expression, the first keyword indicating a start interception position of the message sent by the payment application during the transaction process, the second keyword indicating a start interception position of the message received by the payment application during the transaction process.

15. The terminal device according to claim 11, wherein the processor obtains an expected message corresponding to the actual message by:
reading the expected message from a target document according to a third keyword, the third keyword representing a reading start position of the expected message, and the target document storing the expected message.

16. The terminal device according to claim 11, wherein the processor parses the actual message by:
parsing the actual message according to a data format defined in the configuration file by invoking an interface that is used to parse the message.

17. The terminal device according to claim 11, wherein the processor is further caused to:
obtain a value of a specified field from the message parsing result by invoking a specified field interface of the message;
execute a special transaction of the payment application according to the value of the specified field.

18. A non-transitory storage medium having a computer program stored thereon, when the computer program is executed by a processor of a terminal device, the processor is caused to perform a method for checking message, wherein the method comprises:
obtaining an actual message that is generated by a payment application during a transaction process;
parsing the actual message, and obtaining a corresponding message parsing result;
obtaining an expected message corresponding to the actual message;
checking the message parsing result according to a value of each field of the expected message.

19. The non-transitory storage medium according to claim 18, wherein checking the message parsing result according to a value of each field of the expected message comprises:
determining a verification result of each field of the expected message of the message parsing result according to the value of each field;
determining that a verification result of the message parsing result is valid in response that the verification results of all fields of the expected message of the message parsing result are valid;
determining that a verification result of the message parsing result is invalid in response that the expected message has at least one field whose verification result in the message parsing result is invalid.

20. The non-transitory storage medium according to claim 19, wherein determining a verification result of each field of the expected message of the message parsing result according to the value of each field comprises:
in response that a value of a certain field of the expected message is a first character, determining the certain field to be a first field, and determining whether the message parsing result has the first field, the first character indicating that the message parsing result needs to have the first field;
in response that the message parsing result comprises the first field, determining that the verification result of the first field in the message parsing result is valid;
in response that the message parsing result does not comprise the first field, determining that the verification result of the first field in the message parsing result is invalid;
in response that the value of the certain field of the expected message is a second character, determining that the certain field is a second field, and determining whether the message parsing result does not have the second field, and the second character indicating that the message parsing result does not have the second field;
in response that the message parsing result does not comprise the second field, determining that the verification result of the second field in the message parsing result is valid;
in response that the message parsing result has the second field, determining that the verification result of the second field in the message parsing result is invalid;
in response that the value of the certain field in the expected message is a third character, skipping to determine whether the message parsing result has the field, and the third character indicating that a corresponding field is an optional field of the message parsing result;
in response that the value of the certain field in the expected message is other character, determining that the certain field is other field, and determining whether the message parsing result has the other field, and in response that the message parsing result has the other field, determining whether a value of the other field in the expected message is consistent with the value of the other field in the message parsing result, and the other character representing a character except the first character, the second character and the third character;
in response that the message parsing result has the other field and the value of the other field in the expected message is consistent with the value of the other field in the message parsing result, determining that the verification result of the other field in the message parsing result is valid;
in response that the message parsing result does not has the other field, or has the other field and the value of the other field in the expected message is inconsistent with the value of the other field in the message parsing result, determining that the verification result of the other field in the message parsing result is invalid.

21. The non-transitory storage medium according to claim 18, wherein obtaining an actual message that is generated by a payment application during a transaction process comprises:
obtaining a transaction log that is generated by the payment application during the transaction process; and
intercepting the actual message from the transaction log according to a first keyword and/or a second keyword using a preset regular expression, the first keyword indicating a start interception position of the message sent by the payment application during the transaction process, the second keyword indicating a start interception position of the message received by the payment application during the transaction process.

22. The non-transitory storage medium according to claim 18, wherein obtaining an expected message corresponding to the actual message comprises:
reading the expected message from a target document according to a third keyword, the third keyword representing a reading start position of the expected message, and the target document storing the expected message.

23. The non-transitory storage medium according to claim 18, wherein parsing the actual message comprises:
parsing the actual message according to a data format defined in the configuration file by invoking an interface that is used to parse the message.
